(19) United States
(12) Patent Application Publication
(10) Pub. No.: US 2010/0256024 A1
(43) Pub. Date: Oct. 7, 2010

(54) RESIN COATED PROPPANT SLURRY COMPOSITIONS AND METHODS OF MAKING AND USING SAME

(75) Inventor: Kewei Zhang, Calgary (CA)

Correspondence Address: BRADLEY ARANT BOULT CUMMINGS LLP;INTELLECTUAL PROPERTY DEPARTMENT, 1819 FIFTH AVENUE NORTH, BIRMINGHAM, AL, 35203-2104, US

(73) Assignee: TRICAN WELL SERVICE LTD., Calgary, AB (CA)

(21) Appl. No.: 12/669,178

(22) PCT Filed: Jul. 15, 2008
(86) PCT No.: PCT/CA2008/001293

§ 371 Date: May 31, 2010

Related U.S. Application Data
(60) Provisional application No. 60/929,933, filed on Jul. 18, 2007.

(51) Int. Cl. C09K 8/82; E21B 43/267

(52) U.S. Cl. 507/219; 166/280.2

(57) ABSTRACT

A resin coated proppant slurry and a method for preparing a slurry is provided where the resin coated proppant particles are rendered less dense by attaching stable micro-bubbles to the surface of the resin coated proppants. A collector or frother may be added to enhance the number or stability of bubbles attached to the proppants. This method and composition finds use in many industries, especially in oil field applications.

### FIELD OF THE INVENTION

This invention relates to proppant sand slurry compositions and methods of making and using the same.

### BACKGROUND OF THE INVENTION

Hydraulic fracturing operations are used routinely to increase oil and gas production. In a hydraulic fracturing process, a fracturing fluid is injected through a wellbore into a subterranean formation at a pressure sufficient to initiate a fracture to increase oil and gas production. Frequently, particulates, called proppants, are suspended in the fracturing fluid and transported into the fracture as a slurry. Proppants include sand, resin coated proppants, ceramic particles, glass spheres, bauxite (aluminum oxide), and the like. Among them, sand is by far the most commonly used proppant. Fracturing fluids in common use include various aqueous and hydrocarbon gels. Liquid carbon dioxide and nitrogen gas are also used in fracturing treatments. The most commonly used fracturing fluids are aqueous fluids containing cross-linked polymers to initiate fractures in the formation and effectively transport proppants into the fractures. At the last stage of a fracturing treatment, fracturing fluid is flowed back to surface and proppants are left in the fracture to prevent it from closing back after pressure is released. The proppant-filled fracture provides a high conductive channel that allows oil and/or gas to seep through to the wellbore more efficiently. The conductivity of the proppant pack plays a dominant role in increasing oil and gas production. However it is well known that polymer residues from polymer fracturing fluids greatly reduce the conductivity of the proppant-pack.

Besides normal sand, resin coated proppant is also commonly used in fracturing treatments, especially, to mitigate proppant flowback after a fracturing treatment. The outer surfaces of the resin-coated proppants have an adherent resin coating so that the proppant grains can be bonded to each other under suitable conditions forming a permeable barrier. The substrate materials for the resin-coated proppants include sand, glass beads and organic materials such as shells or seeds. The resins used include epoxy, urea aldehyde, phenol-aldehyde, furfural alcohol and furfural. The resin-coated proppants can be either pre-cured or can be cured by an overflush of a chemical binding agent, commonly known as activator, which often contains a surfactant. Different binding agents have been used. U.S. Pat. Nos. 3,492,147 and 3,935,339 disclose compositions and methods of coating solid particulates with different resins. The particulates which can be coated include sand, nut shells, glass beads, and aluminum pellets. The resins used include urea-aldehyde resins, phenol-aldehyde resins, epoxy resins, furfuryl alcohol resins, and polyester or alkyl resins. The resins can be in pure form or mixtures containing curing agents, coupling agents or other additives. To reduce the proppant flowback, the resin coated proppants are pumped into the near-wellbore formation in the last portion of the sand stage to form a permeable barrier.

The density of proppants is normally much greater than the density of water. The large density difference between proppants and water makes proppant settle quickly in water, even under high turbulence. Once settled, proppant is not easily lifted by the flow of the aqueous liquid in which it has settled.

Conventionally, to make a relatively stable slurry under static or/and dynamic conditions, proppant is commonly suspended in a viscoelastic liquid. In viscoelastic fluids, yield stress plays a dominant role in suspending proppants. Yield stress is the minimum shear stress required to initiate flow in a viscoelastic fluid. Basically, the viscosity of the fluid works to slow down the rate of proppant settling, while the yield stress helps to suspend the proppant. Under dynamic conditions, agitation or turbulence further help stabilize the slurry. Therefore, to make stable and cost-effective proppant slurries, conventional methods focus on manipulating the rheological properties of the liquid medium by adding a sufficient amount of viscosifier, for example, a natural or synthetic polymer, into the slurry to form a viscoelastic fluid. It is not unusual that a polymer is used together with a foaming agent to improve the rheology and to reduce cost.

Flotation has been used in minerals engineering for the separation of finely ground valuable minerals from other minerals. Crude ore is ground to fine powder and mixed with water, collecting reagents and, optionally, frothing reagents. When air is blown through the mixture, hydrophobic mineral particles cling to the bubbles, which rise to form froth on the surface. The waste material (gangue) settles to the bottom. The froth is skimmed off, and the water and chemicals are removed, leaving a clean concentrate. The process, also called the froth-flotation process, is used for a number of minerals.

The primary mechanism in such a flotation process is the selective aggregation of micro-bubbles with hydrophobic particles under dynamic conditions to lift the particles to the liquid surface. The minerals and their associated gangue usually do not have sufficient hydrophobicity to allow bubbles to attach. Collecting agents, known as collectors, are chemical agents that are able to selectively adsorb to desired minerals surfaces and make them hydrophobic to permit the aggregation of the particles and micro-bubbles and thus promote separation. Frothers are chemical agents added to the mixture to promote the generation of semi-stable froth. In the so-called reverse flotation process, the undesired minerals, such as silica sand are floated away from the valuable minerals which remain in the tailings. The reverse flotation of silica is widely used in processing iron as well as phosphate ores.

A wide variety of chemical agents are useful as collectors and frothers for flotation of silica particles. Amines such as simple primary and secondary amines, primary ether amine and ether diamines, tallow amines and tall oil fatty acid/amine condensates are known to be useful collectors for silica particles. It is well established that these chemical compounds strongly adsorb to sand surface and change the sand surface from hydrophilic to hydrophobic to allow form stable sand/bubbles aggregations. The preferred collectors are amine collectors having at least about twelve carbon atoms. Collectors useful in the present invention are amines including simple primary and secondary amines, primary ether amine and ether diamines, tallow amines and tall oil fatty acid/amine condensates. Examples of such collectors include propanamine, 3-nonyloxy-; 1,3-propanediamine, N-tridecyloxy-3,1-propanediyl-; the condensate of diethylenetetraamine and tall oil fatty acid, C₁₆-C₁₈ tallow amine, decylamine, dodecylamine, dihexyl amine, tetradecyloxypropyl amine, dodecyloxypropyl amine, octadecyl/hexadecyloxypropyl amine, isododecyloxypropyl amine, isotridecyloxypropyl amine, dodecyl-1,3-propanediamine, hexadecyl-1,3-propanediamine, tallow-1,3-propanediamine and the condensate of an excess of fatty acids with diethanolamine. Alkanol amines with short carbon chains, such as C₁₋₆ alkanol amines, or short carbon chain amine such as hexylamine can also be combined with long carbon chain amine collectors to enhance the flotation. Such collectors and related compositions for silica are well known in the art. More details can be found in U.S. Pat. Nos. 2,312,387; 2,322,201; 2,710,856; 4,234,414; and 5,124,028; S. Takeda and S. Usui in Colloid and Surfaces, 29, 221-232, 1988; and J. L. Scott and R. W. Smith in Minerals Engineering, Vol. 4, No. 2, 141-150, 1991, which are incorporated herein by reference. Other possible collectors are oleate salts which normally need presence of multivalent cations such as Ca++ or Mg++ to work effectively.

Compounds useful as frothers include low molecular weight alcohols including methyl isobutyl carbinol (MIBC), amyl, hexyl, heptyl and octyl, and diethyl isohexyl alcohols, pine oil and glycol ethers. In floatation process, the collectors and frothers can be used alone or in combination.

For the mineral having natural hydrophobic surface such as coal, the mostly common used collectors are hydrocarbon oils such as kerosene, fuel oil, or a C₅ to C₈ hydrocarbon. In coal flotation, the collectors and frothers can be used alone or in combination. For example, small amount of isooctane or kerosene can be used alone or in combined with pine oil, or small quantity of MIBC or pine oil or hexyl alcohol can acts as both collector and frother in coal flotation.

Such flotation methods are not used in making resin coated proppant slurries.

### SUMMARY OF THE INVENTION

A slurry composition including resin coated proppant and an aqueous liquid.

A slurry composition including resin coated proppant, sand and an aqueous liquid.

A slurry composition including resin coated proppant, an aqueous liquid and a collector.

A slurry composition including resin coated proppant, sand, an aqueous liquid and a collector.

A slurry composition including resin coated proppant, an aqueous liquid and a frother.

A slurry composition including resin coated proppant, sand, an aqueous liquid and a frother.

The slurry composition can be used in different applications including hydraulic fracturing, wellbore clean out, sand control operations in unconsolidated formations.

In one aspect, the present invention relates to a method of making a resin coated proppant slurry composition, the method comprising the steps of: introducing resin coated proppants; mixing the resin coated proppants with an aqueous liquid; and attaching micro-bubbles of sufficient stability to a resin coated proppant surface; wherein the fluidity of the resin coated proppant slurry is increased and transportation of the resin coated proppants is facilitated.

In another aspect, the present invention relates to a method of making a resin coated proppant slurry composition, the method comprising the steps of: introducing resin coated proppants; mixing the resin coated proppants with an aqueous liquid; and creating a plurality of cavities among neighbouring resin coated proppants; wherein the fluidity of the resin coated proppant slurry is increased and transportation of the resin coated proppants is facilitated.

### DETAILED DESCRIPTION OF THE INVENTION

Apart from the conventional approaches, in the present invention, attention is turned away from the rheology of the carrying fluid, and instead focused on the proppant, in particular, resin coated proppants. While in each case the characteristics of resin coated proppant (in this embodiment namely its size distribution and density) are constants, the present invention is directed to improving slurry fluidity and stability by “lifting” the proppants instead of suspending them by the liquid medium.

In one embodiment, the lift is achieved by attaching micro-bubbles of sufficient stability to the resin coated proppant surface. Alternatively, cavities are created among neighboring resin coated proppant grains. The micro-bubbles or cavities attached to the resin coated proppant surfaces help lift them up, due to the resulting increased buoyancy.

In the present invention, the basic principle of flotation is applied to the preparation of aqueous resin coated proppant slurries for transporting the resin coated proppant, which has wide applications, especially in oil field. These applications include hydraulic fracturing, proppant flowback control, wellbore cleanout, sand control operation in unconsolidated formations, sand cleanout in pipeline and sand jetting. The resin coated proppants used in these applications typically range in size from 10 to about 100 mesh. All these applications generally are carried out under dynamic conditions, where turbulence normally exists.

In the present invention, the surfaces of resin coated proppant grains are hydrophobic, while the hydrophobicity can vary from different surface coating. The hydrophobic surface of the resin coated proppant promotes aggregation with micro-bubbles in an aqueous liquid, particularly under dynamic conditions. The term of the aqueous liquid includes water, water containing certain amount of organic or inorganic salts, and water containing small amounts of alcohols or other organic solvents. The aggregation with bubbles provides the resin coated proppants with increased buoyancy and therefore greatly improves the fluidity and stability of the slurry, without employing the viscosifiers.

There are different ways to make resin coated proppant slurries according to the present invention. For example, resin coated proppants can be mixed with water under high agitation, preferably in the presence of gas such as air, nitrogen or carbon dioxide while pumping into a well. It is noted that the conventional surfactants used in the fracturing fluid at normal loading is detrimental to making the slurries according to the present invention. These surfactants, which are normally anionic or non-ionic surfactants or mixtures of surfactants, are added into the fracturing fluid to enhance the flow back of the fracturing fluid after the treatment, by reducing the surface tension of the fluid as low as possible. Without being bound by theory, it is believed that when the surface tension of the aqueous liquid is reduced below a certain value, due to the presence of sufficient amount of surfactant, for example, the micro-bubbles are not capable of being attached to the particulate surface with sufficient stability, and thus forming no particulate/bubble aggregations. Therefore, different from the conventional approach in water fracturing treatment where water or brines is used as fracturing fluid, it is in general undesirable to add anionic or non-ionic surfactants into the resin coated proppant slurry according to the present invention, or only to add them in very small amounts, which is below the critical micelle concentration of the surfactant. The slurry can also be prepared in situ, where resin coated sand, for example, is mixed with water under dynamic conditions, for example, in wellbore cleanout and sand cleanout in pipeline, where liquid flow of high rate is normally applied.

In water fracturing treatment, proppant such as sand settles quickly on the bottom of the fracture and leave the upper and front portions of the fracture unpropped. The less propped fractures compromise the effectiveness of the treatment. In the present invention, similar sized resin coated proppants, for example resin coated sand, can be mixed together with the regular sands and pumped into the formation. Due to the attachment of bubbles to their surfaces, the resin coated sands are more floatable and are more readily to fill up the upper and front portion of the fracture, while the regular sands settle down on the bottom of the fracture. The more wide distribution of the proppants in the fracture provides larger conductive channels resulting in higher production. In addition, since the resin coated proppants are normally several times more expensive than the regular sands, mixing of sands with resin coated proppants reduces the cost significantly.

Another aspect of the present invention is the slurry composition comprising of an aqueous liquid, resin coated proppant, and a collector or a frother, or a mixture of the collector and the frother. One type of the collectors includes hydrocarbon oils, for example, kerosene, fuel oil, or a C₅ to C₈ hydrocarbons. One type of frothers includes low molecular weight alcohols including methyl isobutyl carbinol (MIBC), amyl, hexyl, heptyl and octyl, and diethyl isohexyl alcohols, pine oil and glycol ethers. In the present invention, the collectors and frothers can be used alone or in combination. For example, a small amount of isooctane or kerosene can be used alone or in combined with pine oil, or MIBC or pine oil or hexyl alcohol can be used alone. Another type of collectors is primary and secondary amines, primary ether amine and ether diamines, tallow amines and tall oil fatty acid/amine condensates, which are known to be useful collectors for floating silica particles. For example, this type of collectors can be used when the resin coated proppant and sand are used together in making the slurry according to the present invention.

In general, the collectors have stronger tendency to adsorb on the particulate surfaces than to disperse or dissolve in the aqueous liquid. Depending on the amount of resin coated proppants in the slurry, the addition of the collectors or frothers or their mixtures is generally very small, in the order of ppm. The addition of the collectors or the frothers or their combination enhances the bubble attachment to the particulate surfaces and therefore increases the floatability of the resin coated proppants. The slurry compositions according to the present invention can find many applications, for example, they can be used to effectively transport the resin coated proppants into the fractures during the hydraulic fracturing operations.

The resin coated proppant slurries can be prepared at the surface or under a subterranean formation in situ where the proppant, the aqueous fluid, and a frother, such as hexylalcohol are mixed together under dynamic situations. For example, during a fracturing operation, a collector or a frother or a collector/frother mixture can be added into water and mixed with the resin coated proppant as slurry under high pumping rate to transport the proppant into formation. Optionally, the resin coated proppant and sand are used together. Preferably, nitrogen or carbon dioxide gas is mixed into the slurry. Similarly in wellbore sand cleanout, water containing the collector is mixed with resin coated proppant, for example, resin coated sand, in situ at high flow rate and carries the proppant out the wellbore. Optionally, nitrogen or carbon dioxide gas can be mixed with the fluid.

The following provides several non-limiting examples of the present invention.

### Example 1

100 ml of water and 25 grams of 20/40 US mesh resin coated proppant (SiberProp) were added into a glass bottles (200 ml). The bottles were vigorously shaken and then let to stand to allow the proppant to settle down. It was observed that bubbles are attached to the proppant surface, and moreover there were a layer of proppant floating on the top. When the bottles were tilted slowly, the settled proppant tended to move as cohesive masses.

### Example 2

100 ml of water and 25 grams of 20/40 US mesh resin coated proppant (SiberProp) and 25 grams of 20/40 regular frac sand were added into a glass bottles (200 ml). The bottles were vigorously shaken and then let to stand to allow particulates settle down. It was observed that bubbles are attached to the proppant surface while no bubble attached to the sand surface. All the sand settles to the bottom immediately while a layer of proppant floating on the top.

### Example 3

100 ml of water, 25 grams of 20/40 US mesh resin coated proppant (Atlas PRC) and one drop (˜0.03 ml) of hexyl alcohol were added into a glass bottles (200 ml). The bottles were vigorously shaken and then let to stand to allow the proppant to settle down. It was observed that bubbles are attached to the proppant surface, and moreover there were a layer of proppant containing about 30% of total proppants floating on the top. When the bottles were tilted slowly, the settled proppant tended to move as cohesive masses.

### Example 4

100 ml of water, 25 grams of 25/50 US mesh resin coated proppant (Black) and one drop (˜0.03 ml) of kerosene were added into a glass bottles (200 ml). The bottles were vigorously shaken and then let to stand to allow the proppant to settle down. It was observed that bubbles are attached to the proppant surface, and moreover there were a layer of proppant containing about 10% of total proppants floating on the top. When the bottles were tilted slowly, the settled proppant tended to move as cohesive masses.

### Example 5

100 ml of water, 25 grams of 20/40 US mesh resin coated proppant (Atlas PRC) were added into a glass bottles (200 ml). The bottles were vigorously shaken and then let to stand to allow the proppant to settle down. It was observed that bubbles are attached to the proppant surface, and moreover there were a layer of proppant floating on the top. Further, one drop (−0.03 ml) of Armeen DMHTD, an amine collector from Akzo Nobel, was added into the slurry and vigorously shaken and then let to stand to allow the proppant to settle down. More sand was observed floating on the top.

1. A method of making a resin coated proppant slurry composition, the method comprising the steps of:
(a) introducing resin coated proppants;
(b) mixing the resin coated proppants with an aqueous liquid; and
(c) a step selected from the group consisting of:
(i) attaching micro-bubbles of sufficient stability to a resin coated proppant surface; and
(ii) creating a plurality of cavities among neighbouring resin coated proppants;
wherein the fluidity of the resin coated proppant slurry is increased and transportation of the resin coated proppants is facilitated.

2. (canceled)

3. The method of claim 1, wherein the proppant ranges in size from about 10 to about 100 mesh.

4. The method of claim 1, wherein the aqueous liquid is water, water containing organic or inorganic salts, or water containing alcohol or other organic solvents.

5. The method of claim 1, wherein the proppants are mixed with the aqueous liquid in the presence of a gas.

6. The method of claim 5, wherein the gas is air, nitrogen or carbon dioxide.

7. The method of claim 1, wherein the proppants are mixed with the aqueous liquid under high agitation while pumping into a well.

8. The method of claim 1, further comprising the step of mixing the resin coated proppant with regular sand before pumping into a formation.

9. The method of claim 1, further comprising the step of mixing at least one of a collector and a frother with the aqueous liquid and the resin coated proppants.

10. The method of claim 9, wherein the collector is a hydrocarbon oil.

11. The method of claim 10, wherein the hydrocarbon oil is selected from the group consisting of: kerosene, fuel oil, and a C₅ to C₈ hydrocarbon.

12. The method of claim 9, wherein the collector is selected from the group consisting of: primary amines, secondary amines, primary ether amines, primary ether diamines, tallow amines, and tall oil fatty acid/amine condensates.

13. The method of claim 9, wherein the frother is a low molecular weight alcohol.

14. The method of claim 13, wherein the alcohol is selected from the group consisting of: methyl isobutyl carbinol (MIBC), amyl alcohol, hexyl alcohol, heptyl alcohol, octyl alcohol, diethyl isohexyl alcohols, pine oil and glycol ethers.

15. The method of claim 1, wherein the steps to prepare the resin coated proppant slurry are carried out at the surface.

16. The method of claim 1, wherein the steps to prepare the resin coated proppant slurry are carried out under a subterranean formation in situ under dynamic situations.

17. A slurry composition comprising a resin coated proppant and an aqueous liquid.

18. The slurry composition of claim 17, wherein the proppant ranges in size from about 10 to about 100 mesh.

19. The slurry composition of claim 17, wherein the aqueous liquid is selected from the group consisting of: water, water containing organic salts, water containing inorganic salts, water containing alcohol, and water containing an organic solvent.

20. The slurry composition of claim 17, further comprising a gas.

21. The slurry composition of claim 20, wherein the gas is air, nitrogen or carbon dioxide.

22. The slurry composition of claim 17, further comprising regular sand.

23. The slurry composition of claim 17, further comprising at least one of a collector and a frother.

24. The slurry composition of claim 23, wherein the collector is a hydrocarbon oil.

25. The slurry composition of claim 24, wherein the hydrocarbon oil is selected from the group consisting of: kerosene, fuel oil, and a C₅ to C₈ hydrocarbon.

26. The slurry composition of claim 24, wherein the collector is selected from the group consisting of: primary amines, a secondary amines, primary ether amines, primary ether diamines, tallow amines, and tall oil fatty acid/amine condensates.

27. The slurry composition of claim 23, wherein the frother is a low molecular weight alcohol.

28. The slurry composition of claim 27, wherein the alcohol is selected from the group consisting of: methyl isobutyl carbinol (MIBC), amyl alcohol, hexyl alcohol, heptyl alcohol, octyl alcohol, diethyl isohexyl alcohol, pine oil and glycol ethers.

29. A resin coated proppant slurry that is the product of the method of claim 1.
